(19) United States
(12) Patent Application Publication
(10) Pub. No.: US 2015/0083678 A1
(43) Pub. Date: Mar. 26, 2015

(54) Portable Gear Stand

(71) Applicant: Brian Baughman, Lebanon, OR (US)

(72) Inventor: Brian Baughman, Lebanon, OR (US)

(21) Appl. No.: 14/035,197

(22) Filed: Sep. 24, 2013

(51) Int. Cl. A63K 3/00; A47B 43/00; F16M 11/10; G09F 15/00; F16M 11/28; F16M 11/24

(52) U.S. Cl. CPC A63K 3/00; F16M 11/28; F16M 11/242; F16M 11/10; G09F 15/0068; A47B 43/00
USPC 211/85.3; 211/37; 211/85.7

(57) ABSTRACT

A portable gear stand capable of storing and organizing protective motorcycle or ATV riding equipment is provided. The portable gear stand contains hinged and extendible elements that allow for the quick and easy folding of the stand into a space-saving portable configuration. The portable gear stand may be used by individuals, families, teams, clubs, groups, associations, companies, or any other plurality of persons that wish to store and organize their protective equipment. The portable gear stand may be capable of storing and organizing protective equipment that includes, but is not limited to, boots, goggles, heavy clothes such as a leather jacket and perhaps leather pants, heavy gloves, helmets, and chest protectors. The portable gear stand may also store food and beverages, and have an attachment area for attaching such accessories as signs, advertising, billboards, and umbrellas.

### FIELD OF THE INVENTION

The present invention relates to portable, folding protective equipment stands and, more specifically, to a portable, folding equipment stand for holding riding equipment such as gloves, boots, helmets, and goggles.

### BACKGROUND OF THE INVENTION

It is well known that the survivability of a motorcycle or ATV accident, particularly without serious injury, depends strongly on the type and amount of protective equipment worn by the rider. By way of example, a person in ordinary street clothes may well sustain fatal injuries in an accident in which a person simply wearing a helmet would not. Other types of protective equipment which is used to any substantial extent includes boots, goggles, heavy clothes such as a leather jacket and perhaps leather pants, heavy gloves, helmets, and chest protectors. This type of protective equipment has its limitations however, as it tends to be hot, movement restricting and confining, and inconvenient. Because of the inconvenient nature of protective equipment, many riders tend to remove some or all of their equipment when they're not actively riding.

Many off-road motorcycle and ATV enthusiasts don their protective equipment only when riding. It is very common for them to ride with friends or family for a given amount of time then return to their point of origin and remove much or all of their protective equipment. This cycle of dressing, riding, and undressing can be repeated many times throughout the day. Quite often, the protective equipment is strewn about on pickup tailgates, the motorcycles or ATVs, or whatever happens to provide a convenient surface upon which to lay the item. This can lead to a haphazard, disorganized staging area and makes it very easy for smaller items, such as gloves, to become lost or separated from their mates. What is needed is a convenient apparatus for holding protective equipment when the riders are not currently riding. This apparatus should be portable and lightweight to maximize available space for other necessary pieces of riding equipment. It would also be of tremendous advantage for the apparatus to be foldable, thereby conserving even greater space in a rider's tow or transport vehicle.

Families or groups of individuals enjoy riding motorcycles and ATVs in all weather conditions. This can result in wet or damp protective equipment. Modern composite fabrics and materials provide comfort, insulation, lightweight and effective barriers to external moisture in protective equipment. However, these same properties restrict the removal of perspiration or other moisture from within such equipment. The prior art has clearly demonstrated the benefits of circulating drying air to the interior chambers of such equipment to achieve dryness for next day use. The prior art, however, has not disclosed a protective equipment stand apparatus with drying capabilities which provides safe, convenient, effective, and economical drying of the protective equipment for the entire family. The present invention meets those objectives by providing a convenient, lightweight, portable, folding apparatus for holding protective riding equipment with hollowed tubing to facilitate warm air circulation.

Another concern for motorcycle and ATV riders when storing their protective equipment is the issue of portability. The prior art discloses many devices for storing and organizing protective riding equipment while at home, and keeping the equipment organized and easily accessible in a garage or closet, but the prior art relating to storage and organization of protective riding equipment is lacking in several respects. Stands known in the art are generally affixed in a permanent manner to a wall, floor, ceiling, or in a non-movable free-standing structure. The stands are intended to be installed or set up once then remain in a fixed location. When riders wish to use their motorcycles and ATVs in remote locations they have no easy means for storing and organizing their protective equipment. The present invention meets the need of portability by providing an equipment stand that can be easily folded and taken with the riders when they travel to remote locations.

In large groups it is important to keep the protective riding equipment separate and easily identifiable. Riders typically spend substantial amounts of money and time selecting equipment that precisely meets their specific needs. There are many factors upon which riders base their purchasing decisions and it is not common for protective riding equipment to be easily interchangeable among several riders. Using protective riding equipment that is not the correct size or does not have the correct protective features can pose a significant safety concern. Therefore, it is important for a rider to keep their equipment separate and easily identifiable from other rider's equipment. Furthermore, it can take time and unnecessarily delay or frustrate a rider if they have to sort through piles of protective riding equipment every time they wish to go for a ride. The prior art discloses many equipment stands that can store and organize equipment, but there are no portable protective riding equipment stands that can keep an individual rider's separate and easily distinguishable from the equipment of others. The present invention meets that need by providing a structure that stores an individual's equipment in a manner that makes it easy for a rider to identify and locate their protective riding equipment.

An additional problem with Gear Stands directed to multiple riders is that the stands are most efficiently used only when the maximum number of riders use the stand. While existing Gear Stands for multiple riders allow for convenient organization and storage for the equipment of many riders, when fewer riders use the stand it is no longer efficient. In particular, because the prior art stands are large so that they may hold the equipment of many riders, an individual rider does not generally have a need for such a bulky stand to store his or her own personal equipment. There is thus need for a stand that can be used by an individual as well as by a plurality of riders that does not consume as much space or material as a traditional multiple rider Gear Stand. The present invention meets that need by providing a multiple rider Gear Stand that is roughly of equivalent size to what would be required by a single rider to store his or her protective equipment.

Stands of the prior art tend to be large and difficult to manage. Because of this, another problem results from the fact that many stands will create obstructions. This increases the risk that the equipment will become damaged by people stepping on the equipment or hitting the stands and knocking them over. Accordingly, there is a further need to provide a protective equipment riding stand that does not create an obstruction and that protects the equipment from damage. The present invention meets that need by utilizing a vertically oblong design that minimizes the floor space needed to house the stand.

A further problem of storage stands in the prior art is that they generally lack the ability to distinguish the particular family or group possessing the stand. In particular, it is desirable to have an equipment stand that can display a particular identifier or an item tailored to the individual's own tastes. There is thus a further need for an equipment stand that provides a usable display area. The present invention meets that need by providing an attachment area for securing an identifier or item tailored to the individual's own tastes to the equipment stand.

Furthermore, storage stands found in the prior art are generally limited to holding items such as helmets, goggles, or gloves. It is desirable to have stands that have even greater and more versatile storage capabilities. In particular, during riding events there is often a need to consume beverages to prevent dehydration and to provide nourishment and refreshment. However, most riding locations often lack a convenient place to put beverages or food. This creates the risk that drinks or food become misplaced, lost, or accidentally spilled. There is thus a need to minimize these risks by providing a storage stand capable of securely holding beverages or food.

### BRIEF SUMMARY OF THE INVENTION

It is an object of the present invention to provide an apparatus for storing protective motorcycle or ATV riding equipment when not in use.

It is another object of the present invention to provide an apparatus for organizing the protective riding equipment by keeping the equipment separated and easily identifiable by each person using the apparatus.

It is yet another object of the present invention to provide an apparatus for storing protective motorcycle or ATV riding equipment that is lightweight, foldable, and easily portable.

It is yet another object of the present invention to provide an apparatus for storing protective riding equipment that is designed so as not to create a tripping hazard or obstruction.

It is yet another object of the present invention to provide an apparatus that can be used by an individual, family, group, team, club, company, organization, or any plurality of persons for storing protective riding equipment.

It is yet another object of the present invention to provide an apparatus for storing protective riding equipment that may be used in the field while riding, in a garage or a shop, in a home, or in a business.

It is yet another object of the present invention to provide an apparatus that is small and elongated in shape so as to reduce visual blockage should it become interposed between a spectator and motorcycle and ATV riding area.

It is yet another object of the present invention to provide an apparatus that can circulate warm air through the structure of the apparatus for drying or keeping warm the interior of protective riding equipment. Protective riding equipment that can be kept warm or dried includes, but is not limited to, boots, goggles, heavy clothes such as a leather jacket and perhaps leather pants, heavy gloves, helmets, and chest protectors.

It is yet another object of the present invention to provide an apparatus of durable construction that resists damage from moisture, dirt, debris, or any other elements commonly associated with motorcycle or ATV use.

It is yet another object of the present invention to provide an apparatus with an attachment area that can be used for attaching accessories to the apparatus. These accessories can include, but are not limited to; umbrellas for keeping the protective riding equipment dry; signs or billboards for identifying the owners or users of the apparatus; and an advertising area for displaying a team name, logo, sponsors, or other advertising associated with the owners or users of the apparatus.

It is yet another object of the present invention to provide an apparatus that can hold beverages or food.

In accordance with the objects of the invention described above, one exemplary embodiment of the present invention provides a stand for organizing, protecting, and storing various pieces protective riding equipment. The stand can be used at the location where the owners or users of the stand are riding, or at a location, such as a home or garage, where the riding equipment is typically stored when not in use. The stand is made small and light, making it easily portable even for small children. The stand is constructed of hinged joints so that it is eminently foldable and can be itself stored in a manner that requires minimal space. The stand allows the individual to easily identify the equipment belonging to him or her, and also allows the individual to quickly don the protective riding equipment before embarking on a ride. The stand provides for holding equipment such as boots, goggles, heavy clothes such as a leather jacket and perhaps leather pants, heavy gloves, helmets, and chest protectors, and also contains receptacles for holding beverage or food. The stand is kept out of harm's way through a relatively vertical design that reduces the likelihood of tripping, or causing an obstruction for people moving through the area. Because the stand is small and elongated in shape, there is reduced blockage in the event that the stand is interposed between a spectator and the motorcycle and ATV riding area. The storage stand also provides attachments for personalizing the stand with information such as advertisements, team logos, and names in order to distinguish the stand from that of others, thereby minimizing the risk that equipment will become misplaced or lost.

In accordance with the objects of the invention described above, another exemplary embodiment of the present invention provides a stand for organizing, protecting, and storing various pieces protective riding equipment. The stand may have hollow tubing to facilitate warm air being circulated throughout the structure of the stand. Openings allow for warm air to leave the stand and dry or warm the interior of the protective riding gear that is stored on the stand. A dryer may be attached to the stand to provide the warm air throughout the stand. To further ensure that the protective equipment is kept warm or dry, an umbrella can be attached to the top of the stand to shield it and the protective riding equipment from precipitation.

The present invention may be used by individuals, groups, teams, organizations, the military, or any other plurality of riders. Some, but not all, of the types of vehicles and activities for which the present invention may be used include, but is not limited to: on and off-road motorcycles, ATVs, snowmobiles, jet-skis, boats, recreational teams, bicycles, military personnel and associated activities, snow-skiing, and any other activity that could benefit from having a portable gear stand easily accessible.

The preceding brief description is intended to merely outline some functions and advantages of the present invention. The following disclosure will set forth other functions and advantages of the present invention along with novel features that distinguish the present invention from the prior art. It is to be understood that the following disclosure is by no means intended to limit the scope of the present invention or any of its embodiments. It is also to be understood that the accompanying illustrations are presented for descriptive purposes only and similarly are not intended to limit the scope of present invention or any of its embodiments. The following disclosure and accompanying illustrations may describe various features of novelty that characterize the invention. The invention does not reside any particular feature when taken in the singular, but in the combination of features as described herein.

### BRIEF DESCRIPTION OF THE SEVERAL VIEWS OF THE IMAGE(S)

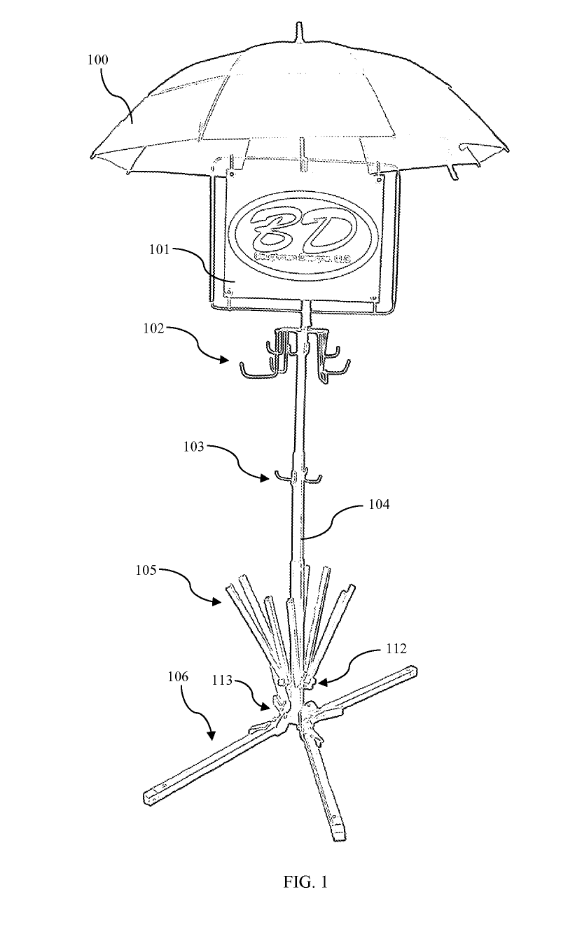

FIG. 1 is a view of a portable gear stand in a deployed configuration as according to one embodiment of the present invention;

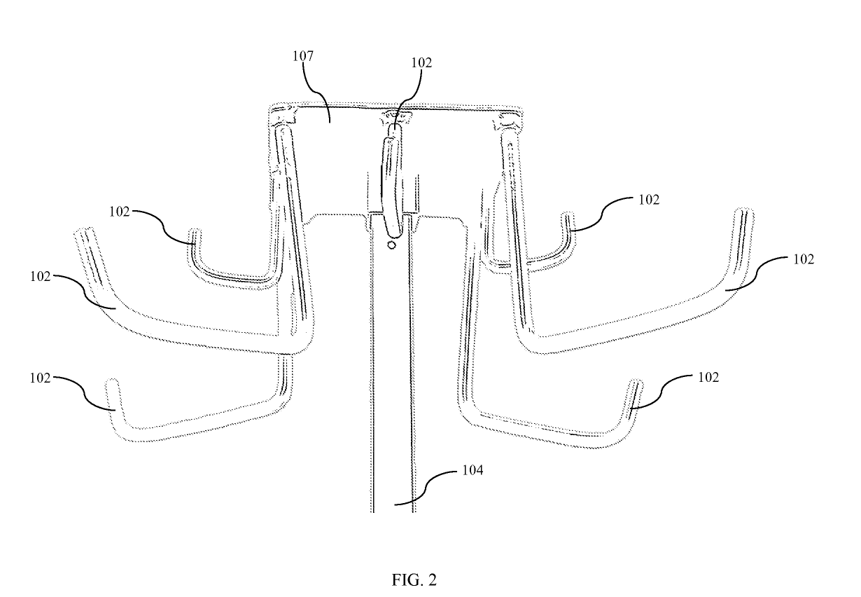

FIG. 2 is a view of upper hooks attached to a mounting plate in a deployed configuration as according to one embodiment of the present invention;

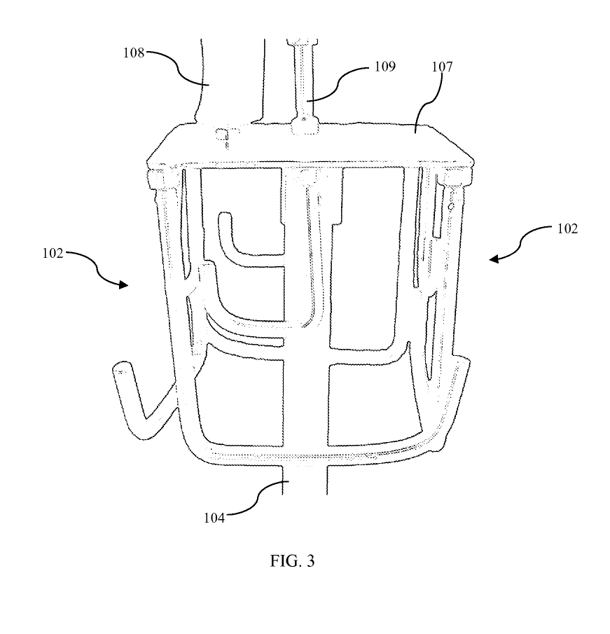

FIG. 3 is a view of upper hooks attached to a mounting plate in storage or transport configuration as according to one embodiment of the present invention;

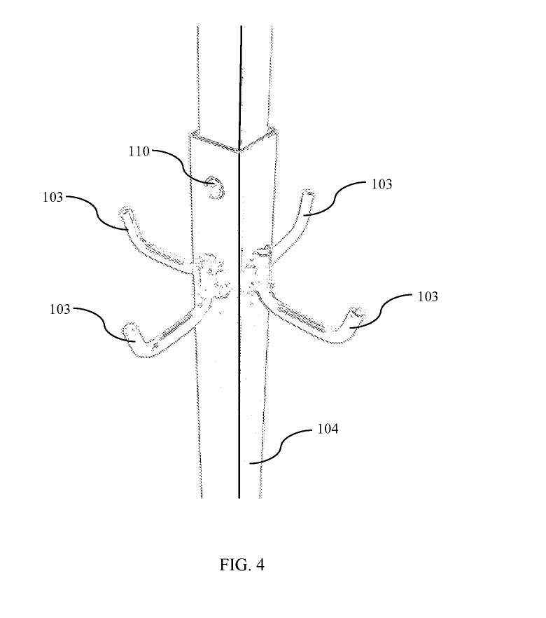

FIG. 4 is a view of middle hooks as according to one embodiment of the present invention;

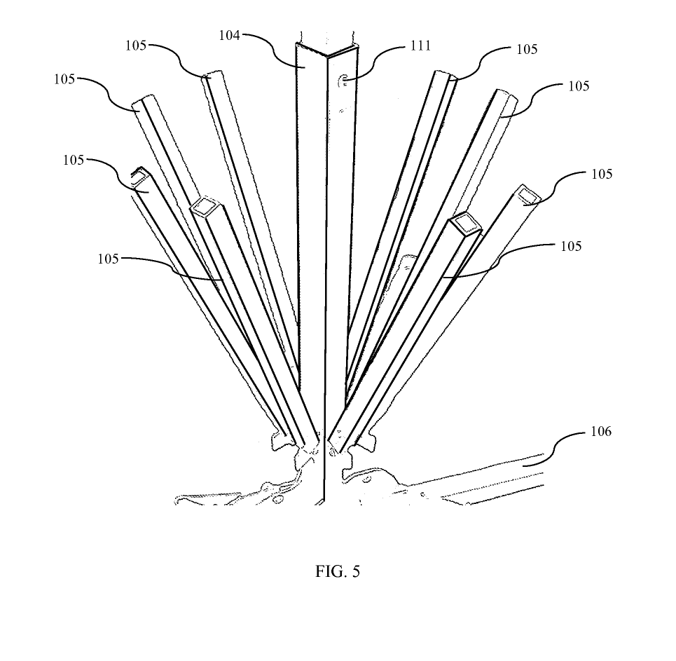

FIG. 5 is a view boot holders as according to one embodiment of the present invention;

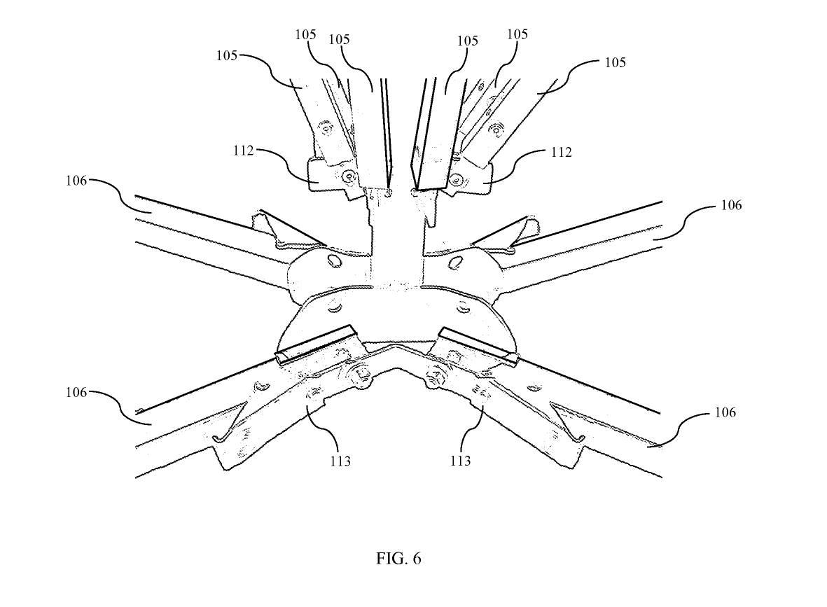

FIG. 6 is a view of the hinge assemblies of boot holders and stand legs as according to one embodiment of the present invention;

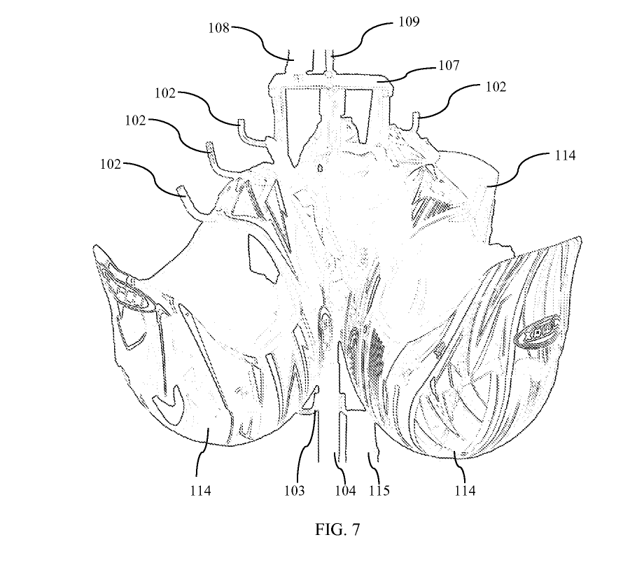

FIG. 7 is a view of gear placed on the hooks of a portable gear stand as according to one embodiment of the present invention;

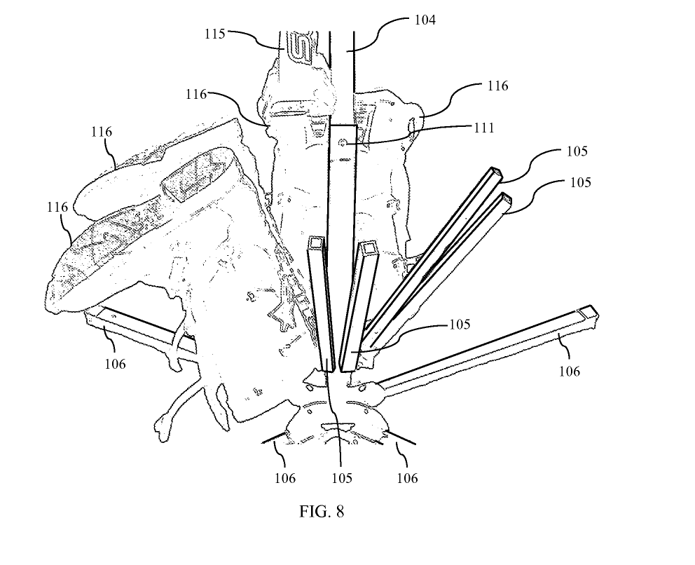

FIG. 8 is a view of boots placed on the boot holders of a portable gear stand as according to one embodiment of the present invention; and

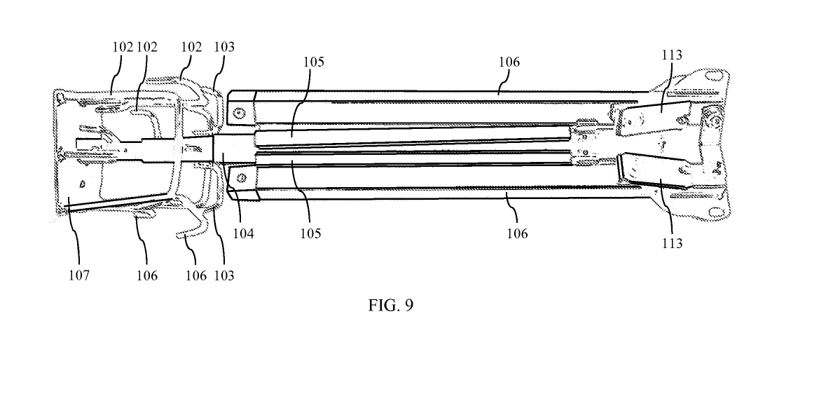

FIG. 9 is a view of a portable gear stand in a folded configuration as according to one embodiment of the present invention.

### DETAILED DESCRIPTION OF THE INVENTION

In the following detailed description, reference is made to the accompanying images that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by appended claims, appropriately interpreted, along with the full range of equivalents to which the claims are entitled.

Further, the purpose of the Abstract herein is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the invention of this application nor is it intended to be limiting as to the scope of the invention in any way.

The word “exemplary” is used herein to mean “serving as an example, instance, or illustration.” Any embodiment described herein as “exemplary” is not necessarily to be construed as preferred or advantageous over other embodiments. Likewise, the terms “embodiment(s) of the invention”, “alternative embodiment(s)”, and “exemplary embodiment(s)” do not require that all embodiments of the apparatus include the discussed feature, advantage or mode of operation. The following descriptions of the preferred embodiments are merely exemplary in nature and is in no way intended to limit the invention, its application, or use.

For the purpose of clarity, all like elements will have the same numbering and designations in each of the images. The terms “portable gear stand”, “gear stand”, “present invention”, and “invention” may be used interchangeably. In addition to the functions, features, components, and abilities of the apparatus already discussed in this specification, the portable gear stand may also have, but not be limited to, the following features contained within the description set forth herein. It should be noted that for purposes of this disclosure, the term “swivelably” means capable of being swiveled, or attached by way of a swivel.

Several preferred embodiments of the portable gear stand are discussed in this section. However, the invention is not limited to these embodiments. A portable gear stand, as according to the present invention, is any gear stand that allows users to store equipment in a manner that keeps the equipment organized and safe from damage and can be folded into a storage or travel configuration when not in use. The gear stored on the portable gear stand includes, but is not limited to, any equipment used when using on or off-road motorcycles, ATVs, snowmobiles, jet-skis, bicycles, boats, or snow-skis. Embodiments of the portable gear stand can also be used by recreational teams and military personnel to store and keep safe their gear. Typically, the gear placed on the gear stand is helmets or hats, boots, gloves, and goggles.

Referring now to FIG. 1, there is shown a portable gear stand in a deployed configuration as according to one embodiment of the present invention. The portable gear stand has a protective covering (100) that shields gear from adverse weather conditions such as rain, sun, snow, hail, or sleet. In some embodiments of the present invention, the protective covering (100) is an umbrella that is detachably mounted to a mounting plate (FIGS. 2, 3, 7, 9 (107)) of the portable gear stand.

The portable gear stand has a sign (101) that bears logos, advertisements, names, or other printed messages. In some embodiments of the present invention, the sign (101) displays the name of the manufacturer of the portable gear stand. In other embodiments of the present invention, the sign (101) displays a team name, or a particular user's name. In yet other embodiments of the present invention, the sign (101) displays sponsor's or a company's name. The sign (101) is detachably mounted to a mounting plate (FIGS. 2, 3, 7, 9 (107)) of the portable gear stand.

The portable gear stand has a set of upper hooks (102) that are swivelably attached to a mounting plate (FIGS. 2, 3, 7, 9 (107)) of the portable gear stand. The upper hooks (102) are swiveled outward when the portable gear stand is deployed, and swiveled inward when the gear stand is transported or stored. Each upper hook (102) is of sufficient strength and durability to hold a single, or multiple, pieces of gear. In one embodiment of the present invention, the upper hooks are used to hold motorcycle helmets, gloves, goggles, or any combination thereof.

The portable gear stand has a set of middle hooks (103) that are attached to an adjustable-length support column (104). The middle hooks (103) provide additional storage options for users and can be used to hold the same type of gear as the upper hooks (102). The middle hooks are positioned around the support column (104) in such a manner as to not interfere or contact other components of the gear stand when the gear stand is collapsed for storage or transport. In some embodiments of the present invention, the middle hooks (103) are used to store goggles or gloves. The adjustable length support column (104) extends and retracts when the gear stand is deployed for use or collapsed for transport. The support column (104) comprises at least two sections that slide together when the gear stand is collapsed.

Boot holders (105) located near the base of the portable gear stand are attached to the support column (104) by boot holder hinges (112). The boot holder hinges (112) allow the boot holders (105) to fold outwards to receive boots, shoes, or other foot coverings. The boot holders (105) are slid into the interior of the boots, shoes, or other foot coverings when the boot holders (105) are in use. The boot holders (105) are oriented around the base of the portable gear stand in pairs so that sets of boots can stored in an organized manner. In some embodiments of the present invention, the boot holders (105) are hollow thereby permitting warm air to be forced through the boot holders (105) and into the boots to dry or warm the boots.

Stand legs (106) are attached to the support column (104) by stand leg hinges (113). The stand legs (106) are folded outward when the gear stand is deployed to stabilize the gear stand and prevent it from toppling. The stand legs (106) are folded inward when the gear stand is collapsed for storage or transport. The stand leg hinges (113) lock the stand legs (106) into a spread arrangement when the gear stand is in use. The stand leg hinges (113) can independently lock the stand legs (106) into different elevations so that the gear stand can be used on sloped or uneven terrain. In some embodiments of the present invention, two of the stand legs (106) are locked into a lower elevation while another two of the stand legs (106) are locked into a higher elevation. The lower stand legs (106) are placed downhill and upper stand legs (106) are placed uphill. The gear stand is kept upright by the appropriate uphill and downhill placement of the stand legs (106).

Referring now to FIG. 2, there is shown a view of upper hooks (102) attached to a mounting plate (107) in a deployed configuration as according to one embodiment of the present invention. The mounting plate (107) is attached to the top of the support column (104). The upper hooks (102) comprise smaller and larger hooks spaced apart from each other so that more gear, and gear of varying sizes, can be stored on the portable gear stand. The upper hooks (102) are swivelably attached to the mounting plate (107) so that they can be swiveled outward when the gear stand is in use, and swiveled inward when the gear stand is collapsed for storage or transport. Gear including, but not limited to, helmets, goggles, gloves, jackets, chest protectors, and riding pants can be hung from the upper hooks (102).

The mounting plate (107) has a relatively flat top surface so that small, loose gear can be placed on top of the gear stand. The mounting plate (107) also has attachments for signs, advertisements, billboards, or umbrellas. In some embodiments of the present invention, the mounting plate (107) provides a convenient area to store food or beverages. By comprising a flat top surface, the mounting plate (107) prevents the food or beverages from spilling or inadvertently getting knocked over as may happen if the food or beverages were placed on the ground.

Referring now to FIG. 3, there is shown a view of upper hooks (102) attached to a mounting plate (107) in a storage or transport configuration as according to one embodiment of the present invention. The upper hooks (102) are shown folded inward so that they take up less space and do not catch on anything when the gear stand is stored or transported. Furthermore, by folding into an area with roughly the same circumference as the mounting plate (107), some embodiments of the present invention can be inserted into a carrying case or storage bag when not in use. Both the larger hooks and smaller hooks of the upper hooks (102) fold inward when the stand is folded or transported.

The mounting plate (107) is shown with optional attachments including an affixed umbrella (108) and a sign base (109). The optional attachments can be quickly and easily detached from the mounting plate (107) when the portable gear stand is collapsed for transport or storage.

Referring now to FIG. 4, there is shown a view of middle hooks (103) as according to one embodiment of the present invention. The middle hooks (103) are attached to the support column (104) and spaced apart from each other to provide maximum storage space and to keep gear properly separated. In the depicted embodiment of the present invention, the middle hooks (103) are shown welded to the support column (104). However, in other embodiments of the present invention the middle hooks (103) can be detachably attached to the support column (104), or swivelably attached to the support column (104).

Also shown in FIG. 4, an upper support column release mechanism (110) keeps the support column (104) locked into an extended position when the gear stand is in use. The upper support column release mechanism (104) is shown as a button-type release latch, but can be any mechanism that locks sections of the support column (104) into place, then releases to allow the support column (104) to be retracted when the gear stand is collapsed for storage or transport.

Referring now to FIGS. 5 and 6 that will be discussed together, there is shown views of boot holders (105) and hinge assemblies (112, 113) as according to an embodiment of the present invention. The boot holders (105) are attached to boot holder hinges (112) that are attached to the support column (104). Here, the support (104) column is shown with a lower support column release mechanism (111) that keeps the support column (104) locked into place when the gear stand is in use. The lower support column release mechanism (111) releases to allow the support column (104) to retract when the gear stand is collapsed for storage or transport.

The boot holder hinges (112) allow the boot holders (105) to pivot outward from the support column (104) when the gear stand is in use, and to pivot inward when the gear stand is collapsed for storage or transport. This embodiment of the present invention shows the boot holders (105) as hollow tubes so that an accessory device may be attached to the gear stand that blows warmed or non-warmed air through the boot holders (105) and into any gear that is placed on the boot holder (105).

The stand legs (106) are attached to stand leg hinges (113) that are attached to the support column (104). The stand leg hinges (113) lock the stand legs (106) into place to support the gear stand when the stand is in use. The stand legs (106) are locked into an arrangement that prevents the gear stand from tipping, even when the gear stand is placed on uneven or sloped terrain. The stand leg hinges (113) allow the stand legs (106) to be locked in different positions so that the stand legs (106) can be set in a variety of elevations. This allows for independent elevation adjustments in each of the stand legs (106). When collapsed for storage or transport, the stand leg hinges (113) lock the stand legs (106) into a storage configuration.

Referring now to FIG. 7, there is shown gear placed on the hooks (102, 103) of a portable gear stand as according to one embodiment of the present invention. The gear in the pictured embodiment comprises helmets (114) that are hung from the upper hooks (102) and goggles (115) that are hung from the middle hooks (103). The separation between the upper hooks (102) and lower hooks (103) allows multiple types of gear to be stored on the portable gear stand without interference or difficulty in accessing gear that stored on the respective hooks. Furthermore, the spacing of the upper hooks (102) along the outside of the mounting plate (107) allows adequate spacing so that multiple helmets (114) can be stored on the upper hooks (102) without damage.

Referring now to FIG. 8, there is shown boots (116) placed on the boot holders (105) of a portable gear stand as according to one embodiment of the present invention. The boots (116) are placed upside-down on the boot holders (105) so that the boot holders (105) slide into the interior of the boots (105). By residing within the interior of the boots (116), some embodiments of the present invention can dry out the boots by having an accessory device attached to the gear stand that blows air through the boot holders (105). In these embodiments, the boot holders (105) are hollow. The air blown through the boot holders (105) can be warm air, or non-warmed air depending on the particular application (105). Non-warmed air may be desirable for footwear with low-temperature glues, or on hot days when the user simply wishes to have their footwear dried, but not heated.

Referring now to FIG. 9, there is shown a portable gear stand in a folded configuration as according to one embodiment of the present invention. The gear stand folds into a small, compact shape when collapsed to allow for easy transport or storage. Attachments have been removed from the mounting plate (107), and the upper hooks (102) have been swiveled inward. The support column (104) has been fully retracted and the boot holders (105) and stand legs (106) have been folded up into their travel position. When in its transport or storage configuration, the gear stand can be inserted into a soft-sided transport bag, or a hard-sided case. The bag or the case secures the gear stand and prevents accidental damage and inadvertent snagging on other items.

As set forth in this description and the attached images, an improved portable gear stand has been developed that improves upon conventional gear stands. The various embodiments of the improved portable gear stand described herein can be used in a wide variety of applications.

The preceding exemplary embodiments are not intended to be limiting, but are merely illustrative for the possible uses of the portable gear stand.

Although certain example apparatus and articles of manufacture have been described herein, the scope of coverage of this patent is not limited thereto. On the contrary, this patent covers all apparatus and articles of manufacture fairly falling within the scope of the invention either literally or under the doctrine of equivalents.

With respect to the above description then, it is to be realized that the optimum dimensional relationships for the parts of the portable gear stand, to include variations in size, materials, shape, form, function and the manner of operation, and use, are deemed readily apparent and obvious to one skilled in the art, and all equivalent relationships to those illustrated in the images and described in the specification are intended to be encompassed by the portable gear stand.

Directional terms such as “front”, “back”, “in”, “out”, “downward”, “upper”, “lower”, “top”, “bottom”, “lateral”, “vertical” and the like may have been used in the description. These terms are applicable to the embodiments shown and described in conjunction with the images. These terms are merely used for the purpose of description in connection with the images and do not necessarily apply to the positions in which the portable gear stand may be used.

Therefore, the foregoing is considered as illustrative only of the principles of the portable gear stand. Further, since numerous modifications and changes will readily occur to those skilled in the art, it is not desired to limit the portable gear stand to the exact construction and operation shown and described, and accordingly, all suitable modifications and equivalents may be resorted to, falling within the scope of the portable gear stand. While the above description describes various embodiments of the present invention, it will be clear that the present invention may be otherwise easily adapted to fit any configuration where a portable gear stand is desired or required.

As various changes could be made in the above constructions without departing from the scope of the invention, it is intended that all matter contained in the above description or shown in the accompanying images shall be interpreted as illustrative and not in a limiting sense.

What is claimed is:

1. An apparatus comprising:
a mounting plate, hooks, a support column, boot holders, and stand legs where: the mounting plate is attached to an end of the support column; a plurality of the hooks are swivelably attached to the mounting plate; a plurality of the hooks are attached to the support column; the support column has at least one release mechanism that allows the support column to be retracted during transport or storage of the apparatus; the boot holders are attached to boot holder hinges, the boot holder hinges being attached to the support column, the boot holder hinges allow the boot holders to swing into a usable position when the apparatus is in use and swing into a storage or transport position when the apparatus is transported or stored; and the stand legs are attached to stand leg hinges, the stand leg hinges being attached to the support column, the stand leg hinges allow the stand legs to swing into a usable position when the apparatus is in use and swing into a storage or transport position when the apparatus is transported or stored.

2. The apparatus of claim 1, wherein attachments can be attached to the top of the mounting plate.

3. The apparatus of claim 2, wherein the attachments are either a sign containing advertising, names, logos, slogans, or a device for protecting the apparatus from adverse weather conditions.

4. The apparatus of claim 1, wherein the boot holders are hollow and allow for an accessory device to be attached to the apparatus, the accessory device capable of pumping warmed, or non-warmed, air through the boot holders and into gear that is stored on the boot holders.

5. The apparatus of claim 1, wherein the stand leg hinges are lockable and lock the stand legs in their usable position when the apparatus is in use and in their storage or transport position when the apparatus is stored or transported.

6. The apparatus of claim 5, wherein the stand leg hinges are capable of independently locking the stand legs in different elevations thereby allowing the apparatus to be used on sloped or uneven terrain.

7. The apparatus of claim 1, wherein the apparatus can fit in a storage bag or case when collapsed into its transport or storage configuration.

8. A portable gear stand comprising:
a mounting plate that is attached to an end of a support column; the support column having one or more sections, each section connected to each other by a release mechanism that locks the support column sections in place and allows the support column to be collapsed into a storage or transport position when the portable gear stand is not in use; one or more swivel hooks that are attached to the mounting plate, the swivel hooks being used to store gear when the portable gear stand is in use; one or more pairs of foldable boot holders that are attached to boot holder hinges, the boot holder hinges being attached to the support column; and one or more stand legs that are attached to stand leg hinges, the stand leg hinges being attached to the support column.

9. The portable gear stand of claim 8, wherein one or more hooks used to store gear are attached to the support column.

10. The portable gear stand of claim 8, wherein the gear stored by the gear stand comprises: equipment used when riding on or off-road motorcycles, ATVs, snowmobiles, jet-skis, bicycles, boats, or snow-skis; or equipment used by recreational teams or military personnel.

11. The portable gear stand of claim 8, wherein the one or more swivel hooks are sufficiently sized to accommodate motorcycle helmets.

12. The portable gear stand of claim 8, wherein the boot holders are hollow and allow warmed or non-warmed air to pass through them into boots stored on the portable gear stand.

13. The portable gear stand of claim 8, wherein the stand leg hinges lock the stand legs into different elevations so that the portable gear stand remains level when used on uneven or sloped terrain.

14. A device for storing helmets, goggles, gloves, boots, jackets, and pants comprising:
a set of upper hooks attached to the underside of a mounting plate that swivel inwards for storage or transport or outwards when the device is in use, the hooks being of sufficient dimensions and spacing from each other to accommodate helmets; a retractable support column that is connected to the bottom of the mounting plate and retracts for storage or transport, or extends when the device is in use; at least one release mechanism that allows the support column to retract or extend; one or more middle hooks that are used to store gear that are attached to a section of the support column, the middle hooks being of sufficient dimensions and spacing from each other to accommodate gloves or goggles; pairs of boot holders that store boots or other types of footwear that are attached to the support column by boot holder hinges; and one or more stand legs that stabilize the device and prevent it from toppling when the device is in use that are attached to stand leg hinges, the stand leg hinges being attached to the support column, the stand leg hinges being lockable and capable of locking the stand legs in different elevations.

15. The device of claim 14, wherein the mounting plate has attachment points for attaching a sign or an apparatus that protects the device from adverse weather conditions.

16. The device of claim 14, wherein the boot holders are hollow and allows air to be pumped into the footwear stored on the boot holders.

17. The device of claim 14, wherein the number of boot holder pairs is four.

18. The device of claim 14, wherein the number of stand legs is four.

19. The device of claim 14, wherein the device can be stored or transported inside of a bag or a carrying case.

20. The device of claim 14, wherein the device is used by an individual, family, group, team, club, company, or organization.
